(19) United States
(12) Patent Application Publication
(10) Pub. No.: US 2022/0063347 A1
(43) Pub. Date: Mar. 3, 2022

(54) TIRE WEAR STATE ESTIMATION SYSTEM

(71) Applicant: The Goodyear Tire & Rubber Company, Akron, OH (US)

(72) Inventors: Sparsh Sharma, Luxembourg City (LU); Kanwar Bharat Singh, Lorenztweiler (LU); Mustafa Ali Arat, Ettelbruck (LU); Pieter-Jan Derluyn, Kehlen (LU)

(21) Appl. No.: 17/343,880

(22) Filed: Jun. 10, 2021

Related U.S. Application Data
(60) Provisional application No. 63/070,506, filed on Aug. 26, 2020.

(51) Int. Cl. B60C 11/24; G01M 17/02

(52) U.S. Cl. CPC B60C 11/246; G01M 17/02; B60C 11/243

(57) ABSTRACT

A tire wear state estimation system includes at least one tire that supports a vehicle. A sensor is mounted on the tire and measures tire parameters. At least one sensor is mounted on the vehicle and measures vehicle parameters. Each one of a plurality of sub-models receives selected tire parameters from the tire mounted sensor and selected vehicle parameters from the vehicle mounted sensor. Each one of the sub-models generates a sub-model wear state estimate, and a model reliability is determined for each one of the sub-models. A supervisory model receives the wear state estimate from each sub-model and the model reliability for each sub-model, and generates a combined wear state estimate for the tire.

### FIELD OF THE INVENTION

The invention relates generally to tire monitoring systems. More particularly, the invention relates to systems that predict tire wear. Specifically, the invention is directed to a system for estimating the wear state of a tire by employing sub-models and determining a comprehensive wear state from the estimates generated by each sub-model.

### BACKGROUND OF THE INVENTION

Tire wear plays an important role in vehicle factors such as safety, reliability, and performance. Tread wear, which refers to the loss of material from the tread of the tire, directly affects such vehicle factors. As a result, it is desirable to monitor and/or measure the amount of tread wear experienced by a tire. For the purpose of convenience, the term “tread wear” may be used interchangeably herein with the term “tire wear”.

One approach to the monitoring and/or measurement of tread wear has been through the use of wear sensors disposed in the tire tread, which has been referred to a direct method or approach. The direct approach to measuring tire wear from tire mounted sensors has multiple challenges. Placing the sensors in an uncured or “green” tire to then be cured at high temperatures may cause damage to the wear sensors. In addition, sensor durability can prove to be an issue in meeting the millions of cycles requirement for tires. Moreover, wear sensors in a direct measurement approach must be small enough not to cause any uniformity problems as the tire rotates at high speeds. Finally, wear sensors can be costly and add significantly to the cost of the tire.

Due to such challenges, alternative approaches have been developed, which involve prediction of tread wear over the life of the tire, including indirect estimates of the tire wear state. These alternative approaches have experienced certain disadvantages in the prior art due to a lack of optimum prediction techniques, which in turn reduces the accuracy and/or reliability of the tread wear predictions.

Prior art indirect estimates of tire wear include statistical models that are based on determinations of particular tire behavior and/or characteristics. For example, indirect wear estimates have been based on: the rolling radius of the tire; the slip of the tire; the frictional energy of the tire; vibration of the tire; cornering stiffness of the tire; braking stiffness of the tire; footprint length of the tire; and analysis of parameter combinations such as tire mileage, weather, and tire construction.

Each of these techniques provides a specific estimate of the tire wear state. However, the reliability of each technique may be affected by a change in external parameters, such as weather, vehicle location, road surface and road roughness, as well as tire physical parameters, such as tire temperature, vehicle load state, and the like. In addition, any one of these techniques may outperform other techniques by providing a more accurate and/or reliable estimate of tire wear based on the tire operating environment and accompanying changes in external and physical parameters. In the prior art, there has been no manner of combining or evaluating the results of each separate technique in real time to arrive at an optimum wear state estimate.

As a result, there is a need in the art for a comprehensive tire wear state estimation system that provides a more accurate and reliable estimate of tire wear state than prior art systems.

### SUMMARY OF THE INVENTION

According to an aspect of an exemplary embodiment of the invention, a tire wear state estimation system is provided. The system includes at least one tire that supports a vehicle. A sensor is mounted on the tire, and the tire mounted sensor measures tire parameters. At least one sensor is mounted on the vehicle, and the vehicle mounted sensor measures vehicle parameters. Each one of a plurality of sub-models receives selected tire parameters from the tire mounted sensor and selected vehicle parameters from the vehicle mounted sensor. Each one of the plurality of sub-models generates a respective sub-model wear state estimate. A reliability is determined for each one of the plurality of sub-models. A supervisory model receives the sub-model wear state estimates and the reliability for each one of the sub-models as inputs. The supervisory model generates a combined wear state estimate for the tire.

### BRIEF DESCRIPTION OF THE DRAWINGS

The invention will be described by way of example and with reference to the accompanying drawings, in which:

FIG. 1 is a perspective view of a vehicle and sensor-equipped tire, partially in section, employed in association with the tire wear state estimation system of the present invention;

FIG. 2 is a schematic plan view of the vehicle shown in FIG. 1;

FIG. 3 is a flow diagram showing aspects of sub-models of the tire wear state estimation system of the present invention;

FIG. 4 is a schematic representation of a supervisory model of a first exemplary embodiment of the tire wear state estimation system of the present invention;

FIG. 5 is a schematic representation of a supervisory model of a second exemplary embodiment of the tire wear state estimation system of the present invention; and

FIG. 6 is a schematic perspective view of the vehicle shown in FIG. 1 with a representation of data transmission to a cloud-based server and a display device.

Similar numerals refer to similar parts throughout the drawings.

### DEFINITIONS

“Axial” and “axially” means lines or directions that are parallel to the axis of rotation of the tire.

“CAN” is an abbreviation for controller area network.

“Circumferential” means lines or directions extending along the perimeter of the surface of the annular tread perpendicular to the axial direction.

“Equatorial centerplane (CP)” means the plane perpendicular to the tire's axis of rotation and passing through the center of the tread.

“Footprint” means the contact patch or area of contact created by the tire tread with a flat surface as the tire rotates or rolls.

“GPS” is an abbreviation for global positioning system.

“Inboard side” means the side of the tire nearest the vehicle when the tire is mounted on a wheel and the wheel is mounted on the vehicle.

“Lateral” means an axial direction.

“Net contact area” means the total area of ground contacting tread elements between the lateral edges around the entire circumference of the tread divided by the gross area of the entire tread between the lateral edges.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“TPMS” is an abbreviation for tire pressure monitoring system.

“Tread element” or “traction element” means a rib or a block element defined by a shape having adjacent grooves.

### DETAILED DESCRIPTION OF THE INVENTION

The present invention provides a system that provides an indirect estimation of tire wear state using a supervisory model which determines a comprehensive tire wear state from tire wear state estimates generated by different sub-models.

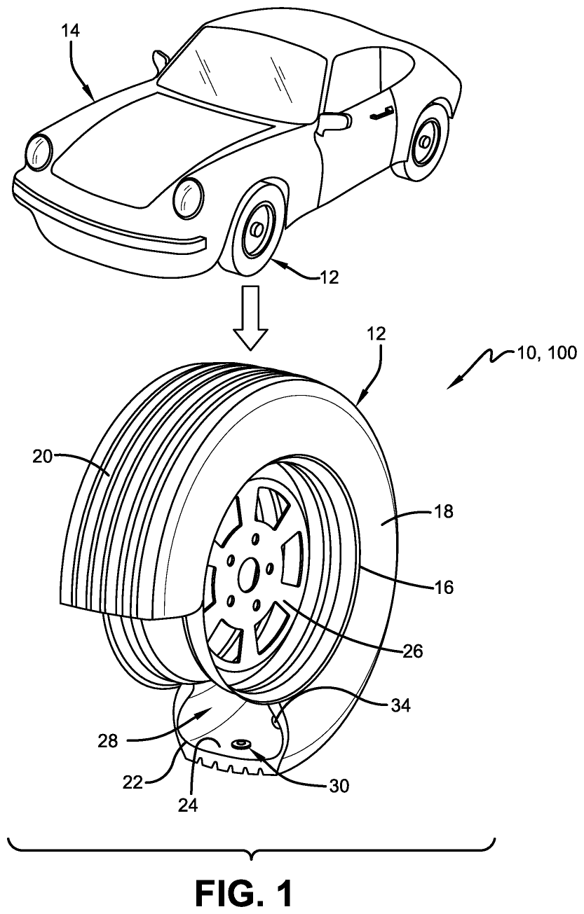

A first exemplary embodiment of the of the tire wear state estimation system of the present invention is indicated at 10 and is shown in FIGS. 1 through 4 and 6. With particular reference to FIG. 1, the system 10 estimates the tire wear state for each tire 12 supporting a vehicle 14. While the vehicle 14 is depicted as a passenger car, the invention is not to be so restricted. The principles of the invention find application in other vehicle categories such as commercial trucks, off-the-road vehicles, and the like, in which vehicles may be supported by more or fewer tires. In addition, the invention finds application in a single vehicle 14 or in fleets of vehicles.

Each tire 12 includes a pair of bead areas 16 (only one shown) and a bead core (not shown) embedded in each bead area. Each one of a pair of sidewalls 18 (only one shown) extends radially outward from a respective bead area 16 to a ground-contacting tread 20. The tire 12 is reinforced by a carcass 22 that toroidally extends from one bead area 16 to the other bead area, as known to those skilled in the art. An innerliner 24 is formed on the inside surface of the carcass 22. The tire 12 is mounted on a wheel 26 in a manner known to those skilled in the art and, when mounted, forms an internal cavity 28 that is filled with a pressurized fluid, such as air.

A sensor unit 30 may be attached to the innerliner 24 of each tire 12 by means such as an adhesive and measures certain parameters or conditions of the tire, as will be described in greater detail below. It is to be understood that the sensor unit 30 may be attached in such a manner, or to other components of the tire 12, such as between layers of the carcass 22, on or in one of the sidewalls 18, on or in the tread 20, and/or a combination thereof. For the purpose of convenience, reference herein shall be made to mounting of the sensor unit 30 on the tire 12, with the understanding that mounting includes all such attachment.

The sensor unit 30 is mounted on each tire 12 for the purpose of detecting certain real-time tire parameters inside the tire, such as tire pressure and temperature. Preferably the sensor unit 30 is a tire pressure monitoring system (TPMS) module or sensor, of a type that is commercially available, and may be of any known configuration. For the purpose of convenience, the sensor unit 30 shall be referred to as a TPMS sensor. Each TPMS sensor 30 preferably also includes electronic memory capacity for storing identification (ID) information for each tire 12, known as tire ID information. Alternatively, tire ID information may be included in another sensor unit, or in a separate tire ID storage medium, such as a tire ID tag 34.

The tire ID information may include manufacturing information for the tire 12, such as: the tire type; tire model; size information, such as rim size, width, and outer diameter; manufacturing location; manufacturing date; a treadcap code that includes or correlates to a compound identification; and a mold code that includes or correlates to a tread structure identification. The tire ID information may also include a service history or other information to identify specific features and parameters of each tire 12, as well as mechanical characteristics of the tire, such as cornering parameters, spring rate, load-inflation relationship, and the like. Such tire identification enables correlation of the measured tire parameters and the specific tire 12 to provide local or central tracking of the tire, its current condition, and/or its condition over time. In addition, global positioning system (GPS) capability may be included in the TPMS sensor 30 and/or the tire ID tag 34 to provide location tracking of the tire 12 during transport and/or location tracking of the vehicle 14 on which the tire is installed.

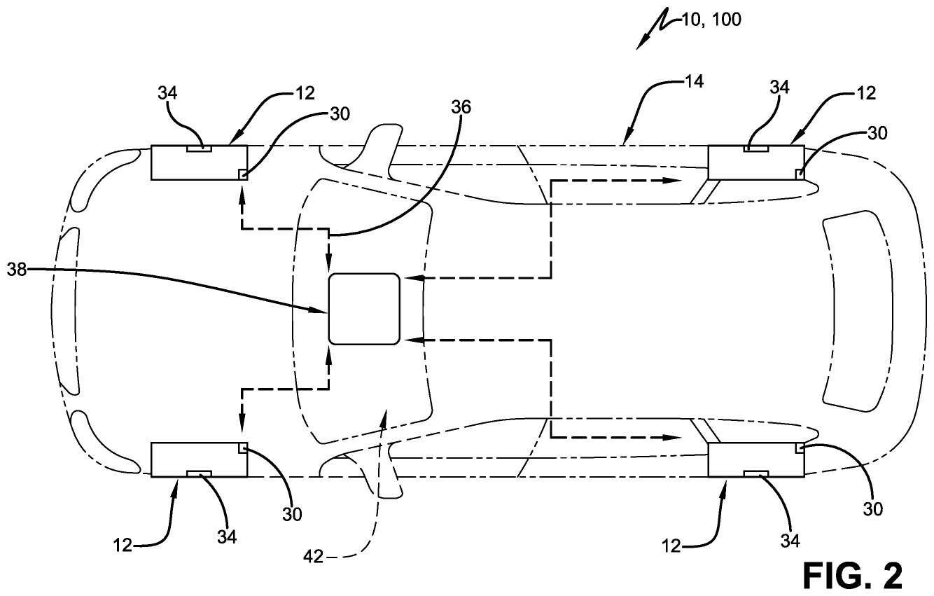

Turning now to FIG. 2, the TMPS sensor 30 and the tire ID tag 34 each include an antenna for wireless transmission 36 of the measured tire temperature, as well as tire ID data, to a processor 38. The processor 38 may be mounted on the vehicle 14 as shown, or may be integrated into the TPMS sensor 30. For the purpose of convenience, the processor 38 will be described as being mounted on the vehicle 14, with the understanding that the processor may alternatively be integrated into the TPMS sensor 30. Preferably, the processor 38 is in electronic communication with or integrated into an electronic system of the vehicle 14, such as the vehicle CAN bus system 42, which is referred to as the CAN bus.

Aspects of the tire wear state estimation system 10 preferably are executed on the processor 38 or another processor that is accessible through the vehicle CAN bus 42, which enables input of data from the TMPS sensor 30 and the tire ID tag 34, as well as input of data from other sensors that are in electronic communication with the CAN bus. In this manner, the tire wear state estimation system 10 enables measurement of tire temperature and pressure with the TPMS sensor 30, which preferably is transmitted to the processor 38. Tire ID information preferably is transmitted from the tire ID tag 34 to the processor 38. The processor 38 preferably correlates the measured tire temperature, measured tire pressure, the measurement time, and ID information for each tire 12.

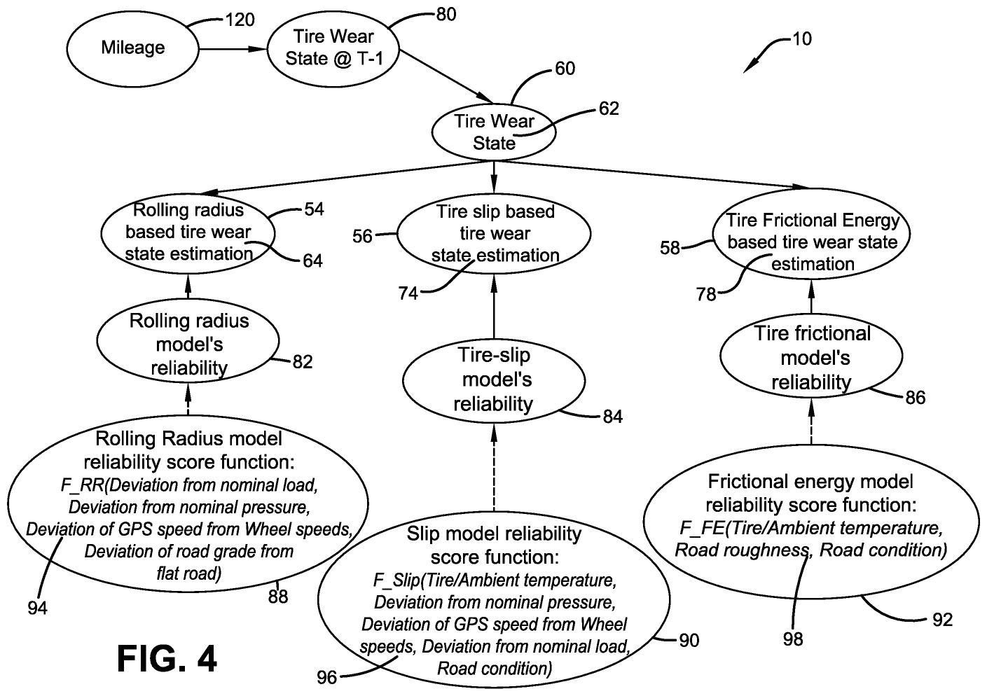

Turning to FIG. 4, the first exemplary embodiment of the tire wear state estimation system 10 includes a supervisory model 60. The supervisory model 60 infers the reliability of multiple sub-models or estimators with reliability score functions that calculate a reliability score of each sub-model based on external or physical parameters. The inferred reliability of each sub-model is combined with the individual estimates of the tire wear state from each sub-model, to generate a single combined wear state estimate 62. A preferred supervisory model 60 is a Bayesian Network, which is a probabilistic graphical model that represents a set of variables and their conditional dependencies through a directed acyclic graph. Of course, other types of prediction models may be used for the supervisory model 60.

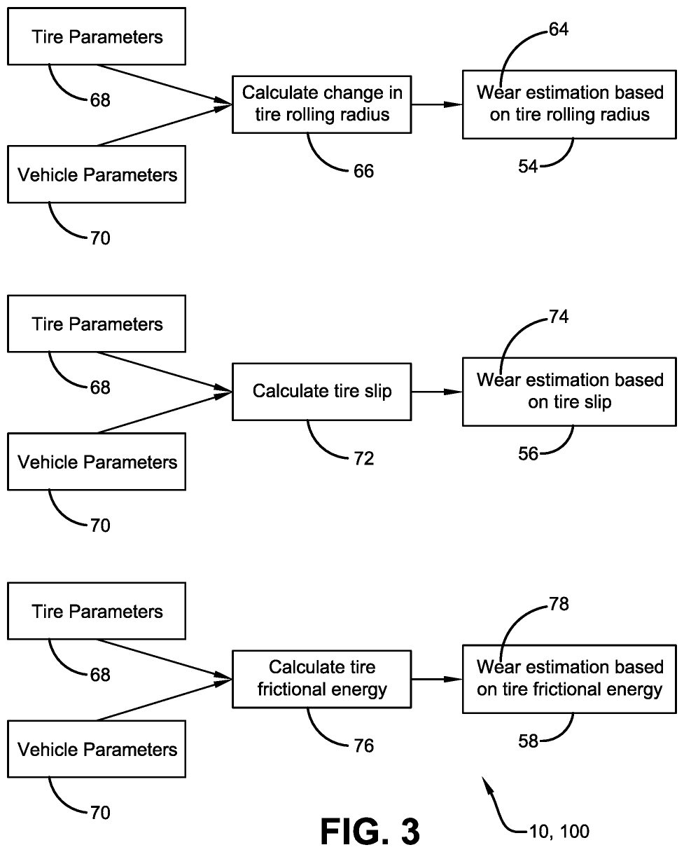

The sub-models or estimators analyzed by the supervisory model 60 include a rolling radius based wear state estimator 54, a slip based wear state estimator 56 and a frictional energy-based wear state estimator 58. Referring to FIG. 3, an exemplary rolling radius based wear state estimator 54 includes a rolling radius calculator 66 that calculates a change in the radius of the tire 12 to generate a rolling radius wear estimate 64. Other sub-models that may be analyzed by the supervisory model 60 include: a vibration based wear state estimator; a cornering stiffness based wear state estimator; a braking stiffness based wear state estimator; a footprint length based wear state estimator; and a tire wear state estimator based on analysis of parameter combinations such as tire mileage, weather, and tire construction.

In the rolling radius based wear state estimator 54, tire parameters 68 obtained from the TPMS sensor 30, such as pressure, temperature and ID, are input into the rolling radius calculator 66. In addition, vehicle parameters 70 are measured by sensors that are mounted on the vehicle 14, and which are in electronic communication with the vehicle CAN bus system 42 (FIG. 2). Specifically, vehicle parameters 70, such as wheel speed, vehicle speed, acceleration and/or position are obtained and input into the rolling radius calculator 66.

The rolling radius calculator 66 calculates a change in the radius of the tire 12 based on the tire parameters 68 and the vehicle parameters 70, which is used by the rolling radius based wear state estimator 54 to generate the rolling radius wear estimate 64. An exemplary technique for determining the rolling radius wear estimate 64 is described in U.S. Pat. Nos. 9,663,115; 9,878,721; and 9,719,886, which owned by the same assignee as the present invention, The Goodyear Tire & Rubber Company, and which are hereby incorporated by reference.

An exemplary slip based wear state estimator 56 includes a tire slip calculator 72 that calculates slip of the tire 12 to generate a slip based wear state estimate 74. In the slip based wear state estimator 56, tire parameters 68 obtained from the TPMS sensor 30, such as pressure, temperature and ID, are input into the tire slip calculator 72. In addition, vehicle parameters 70, such as wheel speed, vehicle speed, and/or acceleration are obtained and input into the tire slip calculator 72.

The slip calculator 72 calculates slip of the tire 12 based on the tire parameters 68 and the vehicle parameters 70, which is used by the slip based wear state estimator 56 to generate the slip based wear state estimate 74. Exemplary techniques for determining the slip based wear state estimate 74 are described in U.S. Pat. Nos. 9,610,810; 9,821,611; and 10,603,962, which are owned by the same assignee as the present invention, The Goodyear Tire & Rubber Company, and which are hereby incorporated by reference.

An exemplary a frictional energy based wear state estimator 58 includes a tire frictional energy calculator 76 that calculates frictional energy of the tire 12 to generate a frictional energy based wear estimate 78. In the frictional energy based wear state estimator 58, tire parameters 68 obtained from the TPMS sensor 30, such as pressure, temperature and ID, are input into the frictional energy calculator 76. In addition, vehicle parameters 70, such as vehicle inertia and/or location are obtained and input into the frictional energy calculator 76.

The frictional energy calculator 76 calculates frictional energy of the tire 12 based on the tire parameters 68 and the vehicle parameters 70, which is used by the frictional energy based wear state estimator 58 to generate the frictional energy based wear estimate 78. An exemplary technique for determining the frictional energy based wear estimate 78 is described in U.S. Pat. No. 9,873,293, which is owned by the same assignee as the present invention, The Goodyear Tire & Rubber Company, and which is hereby incorporated by reference.

As described above, other sub-models that may be analyzed by the supervisory model 60. Exemplary techniques for determining a vibration based wear state estimate are described in U.S. Pat. Nos. 9,259,976 and 9,050,864, as well as U.S. Patent Application Publication Nos. 2018/0154707 and 2020/0182746, which are owned by the same assignee as the present invention, The Goodyear Tire & Rubber Company, and which are hereby incorporated by reference. An exemplary technique for determining a cornering stiffness based wear state estimate is described in U.S. Pat. No. 9,428,013, which is owned by the same assignee as the present invention, The Goodyear Tire & Rubber Company, and which is hereby incorporated by reference.

An exemplary technique for determining a braking stiffness based wear state estimate is described in U.S. Pat. No. 9,442,045, which is owned by the same assignee as the present invention, The Goodyear Tire & Rubber Company, and which is hereby incorporated by reference. Exemplary techniques for determining a footprint length based wear state estimator are described in U.S. Patent Application Ser. Nos. 62/893,862; 62/893,852; and 62/893,860, which are owned by the same assignee as the present invention, The Goodyear Tire & Rubber Company, and which are hereby incorporated by reference. An exemplary technique for determining a tire wear state estimate based on analysis of parameter combinations such as tire mileage, weather, and tire construction is described in U.S. Patent Application Publication No. 2018/0272813, which is owned by the same assignee as the present invention, The Goodyear Tire & Rubber Company, and which is hereby incorporated by reference.

Returning to FIG. 4, the tire wear state estimation system 10 calculates the reliabilities of the sub-models or estimators and inputs them into the supervisory model 60 to generate the combined wear state estimate 62. Reference herein is made by way of example to the rolling radius based wear state estimator 54, the slip based wear state estimator 56 and the frictional energy based wear state estimator 58. More particularly, a respective model reliability score 82, 84 and 86 is determined for each of the rolling radius based wear state estimator 54, the slip based wear state estimator 56 and the frictional energy based wear state estimator 58 based on external and physical parameters to which each estimator is sensitive, referred to as sensitivity parameters.

For example, the rolling radius model reliability score 82 is determined using a rolling radius reliability score function 88. Rolling radius sensitivity parameters 94 are factors that are unaccounted for in the rolling radius based wear state estimator 54 and are known to affect the reliability of the rolling radius wear estimate 64. The sensitivity parameters 94 include: the loading state of the vehicle 14, namely, the deviation of the current vehicle load from a nominal vehicle loading state; extreme high or low tire inflation pressure conditions, namely, the deviation of the tire inflation pressure from a nominal inflation pressure range; the road grade state, namely, the deviation of the grade of the road on which the vehicle is traveling from a flat road condition; and GPS status, namely, the deviation of the vehicle speed indicated by the vehicle GPS from non-driven wheel speeds. These sensitivity parameters 94 are input into the rolling radius reliability score function 88, which scores the parameters with a statistical modeling technique, such as a regression technique, a machine learning model, and/or a fuzzy logic technique or function, to generate the rolling radius model reliability score 82.

The slip based model reliability score 84 is determined using a slip based reliability score function 90. Slip based sensitivity parameters 96 are factors that are unaccounted for in the slip based wear state estimator 56 and are known to affect the reliability of the slip based wear state estimate 74. The sensitivity parameters 96 include: the loading state of the vehicle 14, namely, the deviation of the current vehicle load from a nominal vehicle loading state; extreme high or low tire inflation pressure conditions, namely, the deviation of the tire inflation pressure from a nominal inflation pressure range; GPS status, namely, the deviation of the vehicle speed indicated by the vehicle GPS from non-driven wheel speeds; the ambient temperature of the tire 12; and the road surface condition, namely, the surface characteristics of the road on which the vehicle is traveling as indicated by a frictional coefficient. These sensitivity parameters 96 are input into the slip based reliability score function 90, which scores the parameters with a statistical modeling technique, such as a regression technique, a machine learning model, and/or a fuzzy logic technique or function, to generate the slip based model reliability score 84.

The frictional energy based model reliability score 86 is determined using a frictional energy based reliability score function 92. Frictional energy based sensitivity parameters 98 are factors that are unaccounted for in the frictional energy based wear state estimator 58 and are known to affect the reliability of the frictional energy based wear estimate 78. The sensitivity parameters 98 include: the ambient temperature of the tire 12; the road surface condition, namely, the surface characteristics of the road on which the vehicle 14 is traveling as indicated by a frictional coefficient; and the road roughness condition, namely, the roughness of the road on which the vehicle is traveling as indicated by an international roughness index (IRI). These sensitivity parameters 98 are input into the frictional energy based reliability score function 92, which scores the parameters with a statistical modeling technique, such as a regression technique, a machine learning model, and/or a fuzzy logic technique or function, to generate the frictional energy based model reliability score 86.

The rolling radius wear estimate 64 generated by the rolling radius based wear state estimator 54 and the rolling radius model's reliability score 82 are input into the supervisory model 60. The slip based wear estimate 74 generated by the slip based wear state estimator 56 and the slip based model's reliability score 84 are also input into the supervisory model 60. Additionally, the frictional energy based wear estimate 78 generated by the frictional energy based wear state estimator 58 and the frictional energy based model's reliability score 86 are input into the supervisory model 60.

The tire wear state estimation system 10 preferably also includes an estimate of tire wear state at a previous time step 80, which may be referred to as the tire wear state at T−1. Because the tire 12 continues to wear as time progresses, the estimate of tire wear state at the previous time step 80 improves the current estimate of tire wear state 62. Thus, the estimate of tire wear state at the previous time step 80 preferably is also input into the supervisory model 60. When the estimate of tire wear state at the previous time step 80 is not available, a mileage 120 of the vehicle 14 may be input into the supervisory model 120 to enable an estimate of the tire wear state at a previous time step to be obtained.

The supervisory model 60 thus receives the rolling radius model's wear estimate 64, the rolling radius model's reliability score 82, the slip based model's wear estimate 74, the slip based model's reliability score 84, the frictional energy based model's wear estimate 78, the frictional energy based model's reliability score 86 and the estimate of tire wear state at the previous time step 80 as inputs. The supervisory model 60 then executes a statistical inference to determine a probability distribution over the tire wear states, indicating the single most likely combined wear estimate 62. When a Bayesian Network is employed as the supervisory model 60, the wear estimate 62 is generated by performing a Bayesian inference.

In this manner, the first embodiment of the tire wear state estimation system 10 of the present invention provides an accurate and reliable estimate of tire wear state 62 using a supervisory model 60. The supervisory model determines the comprehensive wear state 62 from estimates generated by multiple sub-models 54, 56 and 58.

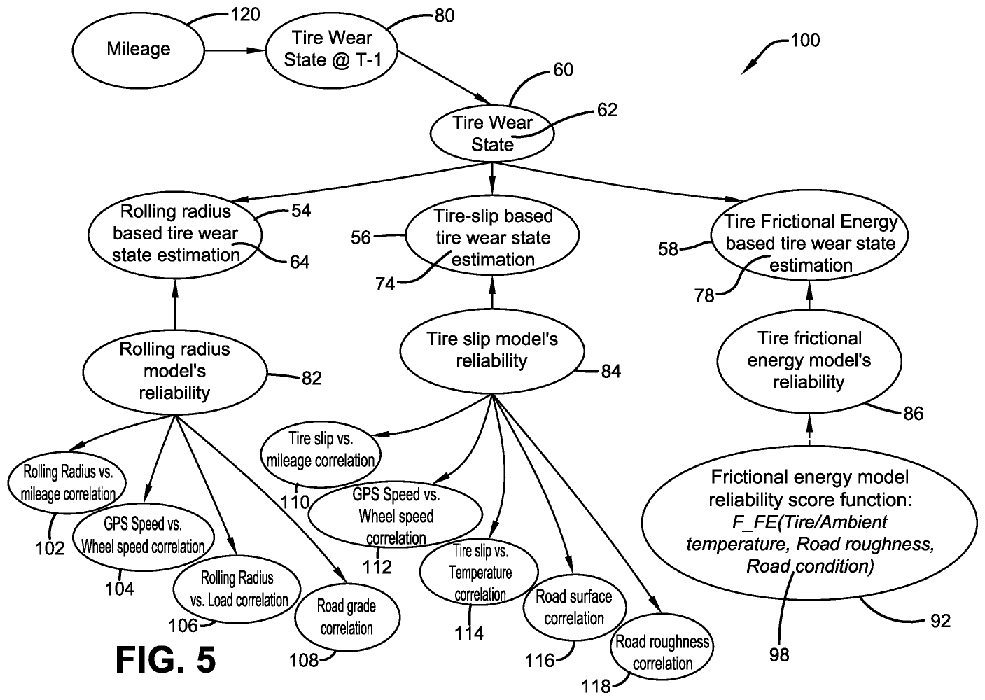

Referring now to FIGS. 1 through 3 and 5 through 6, a second exemplary embodiment of the of the tire wear state estimation system of the present invention is indicated at 100. The second embodiment of the tire wear state estimation system 100 is similar in structure and operation to the first embodiment of the tire wear state estimation system 10, with the exception that the rolling radius model reliability score 82 and the slip based model reliability score 84 are determined differently in the second embodiment of the tire wear state estimation system. Therefore, only the differences between the second embodiment of the tire wear state estimation system 100 and the first embodiment of the tire wear state estimation system 10 will be described.

In the second embodiment of the tire wear estimation system 100, the rolling radius model's reliability 82 is inferred using multiple correlations. For example, a first rolling radius correlation 102 includes correlating the rolling radius of the tire 12 to the mileage of the vehicle 14. A second rolling radius correlation 104 includes correlating the global positioning system (GPS) speed to the wheel speeds of the vehicle 14. A third rolling radius correlation 106 includes correlating the rolling radius of the tire 12 to the vehicle load. A fourth rolling radius correlation 108 is related to the grade of the road on which the vehicle 14 is travelling. These correlations 102, 104, 106 and 108 are used by the supervisory model to infer the reliability 82 of the rolling radius model. When a Bayesian Network is employed as the supervisory model 60, the reliability 82 is inferred by performing a Bayesian inference.

The slip based model's reliability 84 is also inferred using multiple correlations. A first slip based correlation 110 includes a correlation between the slip of the tire 12 and the mileage of the vehicle 14. A second slip based correlation 112 includes a correlation between the global positioning system (GPS) speed to the wheel speeds of the vehicle 14. A third slip based correlation 114 includes correlating the slip of the tire 12 to the temperature of the tire. A fourth slip based correlation 116 is related to the surface characteristics of the road on which the vehicle 14 is travelling. A fifth correlation 118 is related to the roughness of the road on which the vehicle 14 is traveling. These correlations 110, 112, 114, 116 and 118 are used by the supervisory model to infer the reliability 84 of the slip based model . When a Bayesian Network is employed as the supervisory model 60, the reliability 84 is inferred by performing a Bayesian inference.

As with the first embodiment of the tire wear state estimation system 10, in the second embodiment of the tire wear state estimation system 100, the supervisory model 60 receives the rolling radius model's wear estimate 64, the rolling radius model's reliability 82, the slip based model's wear state estimate 74, the slip based model's reliability 84, the frictional energy based model's wear estimate 78, the frictional energy based model's reliability score 86 and the estimate of tire wear state at the previous time step 80 as inputs. The supervisory model 60 then executes a statistical inference to determine a probability distribution over the tire wear states, this helps indicate the single most likely combined wear estimate 62. When a Bayesian Network is employed as the supervisory model 60, the wear estimate 62 is generated by performing a Bayesian inference.

In this manner, the second embodiment of the tire wear state estimation system 100 of the present invention provides an accurate and reliable estimate of tire wear state 62 using a supervisory model 60. The supervisory model 60 determines the comprehensive wear state 62 from estimates generated by multiple sub-models 54, 56 and 58.

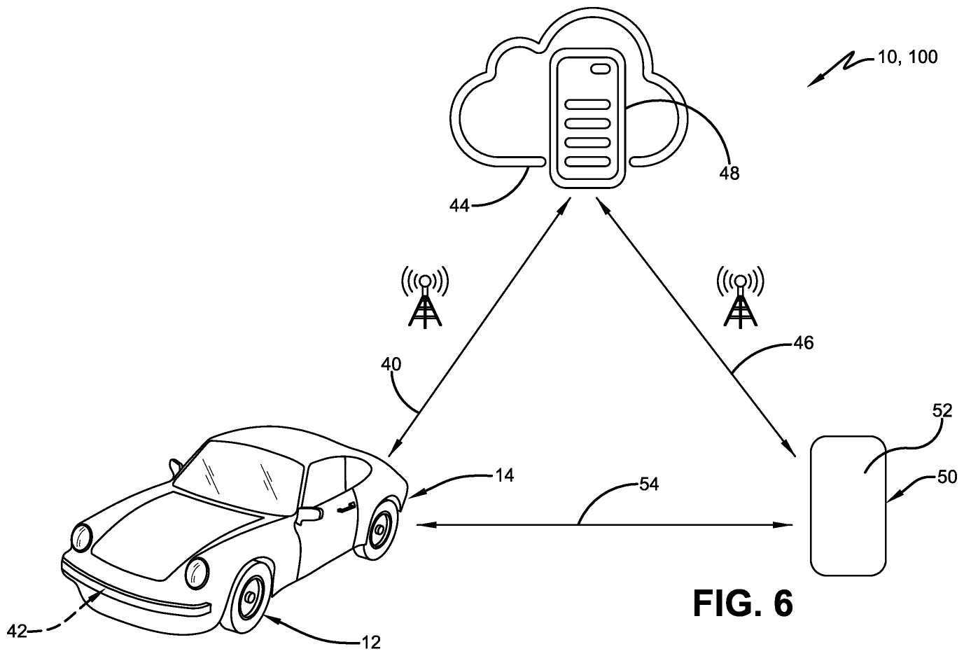

As shown in FIG. 6, tire parameters 68 for each tire 12 vehicle parameters 70 for the vehicle 14 may be wirelessly transmitted 40 from the processor 38 and/or the CAN-bus 42 on the vehicle to a remote processor 48, such as a processor in a cloud-based server 44. The cloud-based server 44 may execute aspects of the tire wear state estimation system 10, 100. The tire wear state estimate 62 may be wirelessly transmitted 46 to a device 50, such as a fleet management server or a vehicle operator device, which includes a display 52 for showing the estimated wear state to a fleet manager or to an operator of the vehicle 14.

The present invention also includes a method of estimating the wear state 62 of a tire 12. The method includes steps in accordance with the description that is presented above and shown in FIGS. 1 through 6.

It is to be understood that the structure and method of the above-described tire wear state estimation system 10, 100 may be altered or rearranged, or components or steps known to those skilled in the art omitted or added, without affecting the overall concept or operation of the invention.

The invention has been described with reference to preferred embodiments. Potential modifications and alterations will occur to others upon a reading and understanding of this description. It is to be understood that all such modifications and alterations are included in the scope of the invention as set forth in the appended claims, or the equivalents thereof.

What is claimed is:

1. A tire wear state estimation system comprising:
at least one tire supporting a vehicle;
a sensor mounted on the at least one tire, the tire mounted sensor measuring tire parameters;
at least one sensor mounted on the vehicle, the at least one vehicle mounted sensor measuring vehicle parameters;
a plurality of sub-models, wherein each sub-model receives selected tire parameters from the tire mounted sensor and selected vehicle parameters from the at least one vehicle mounted sensor;
a plurality of sub-model wear state estimates, each one of the sub-model wear state estimates being generated by a respective one of the plurality of sub-models;
a model reliability being determined for each one of the plurality of sub-models; and
a supervisory model, the supervisory model receiving as inputs the plurality of sub-model wear state estimates and the model reliability for each one of the plurality of sub-models, wherein the supervisory model generates a combined wear state estimate for the at least one tire.

2. The tire wear state estimation system of claim 1, wherein the supervisory model executes a Bayesian inference to determine a probability distribution over the plurality of sub-models in generating the combined wear state estimate.

3. The tire wear state estimation system of claim 1, wherein plurality of sub-models includes a rolling radius based wear state estimator.

4. The tire wear state estimation system of claim 3, wherein the rolling radius based wear state estimator includes a rolling radius calculator, and the rolling radius calculator receives the selected tire parameters and the selected vehicle parameters to calculate a change in a radius of the at least one tire.

5. The tire wear state estimation system of claim 3, wherein the model reliability for the rolling radius based wear state estimator includes a rolling radius reliability score function that scores rolling radius sensitivity parameters to generate the model reliability score for the rolling radius based wear state estimator.

6. The tire wear state estimation system of claim 5, wherein the rolling radius sensitivity parameters include at least one of a loading state of the vehicle, inflation pressure conditions, a road grade state, and a global positioning system status.

7. The tire wear state estimation system of claim 3, wherein the model reliability for the rolling radius based wear state estimator is generated by inferring a plurality of correlations.

8. The tire wear state estimation system of claim 7, wherein the plurality of correlations includes at least one of a correlation of a rolling radius of the at least one tire to a mileage of the vehicle, a correlation of a global positioning system speed to a wheel speed of the vehicle, a correlation between a rolling radius of the at least one tire to a vehicle load, and a correlation of a grade of a road on which the vehicle travels.

9. The tire wear state estimation system of claim 1, wherein plurality of sub-models includes a slip based wear state estimator.

10. The tire wear state estimation system of claim 9, wherein the slip based wear state estimator includes a tire slip calculator, and the tire slip calculator receives the selected tire parameters and the selected vehicle parameters to calculate the slip of the at least one tire.

11. The tire wear state estimation system of claim 9, wherein the model reliability for the slip based wear state estimator is calculated through a slip based reliability score function that scores slip based sensitivity parameters.

12. The tire wear state estimation system of claim 11, wherein the slip based sensitivity parameters include at least one of a loading state of the vehicle, inflation pressure conditions, a global positioning system status, an ambient temperature of the at least one tire, and a road surface condition.

13. The tire wear state estimation system of claim 3, wherein the model reliability for the slip based wear state estimator is inferred through a plurality of correlations.

14. The tire wear state estimation system of claim 13, wherein the plurality of correlations includes at least one of a correlation between a slip of the at least one tire and a mileage of the vehicle, a correlation between a global positioning system speed to wheel speeds of the vehicle, a correlation of a slip of the at least one tire to a temperature of the at least one tire, a correlation of surface characteristics of a road on which the vehicle travels, and a correlation of a roughness of a road on which the vehicle travels.

15. The tire wear state estimation system of claim 1, wherein plurality of sub-models includes a frictional energy based wear state estimator.

16. The tire wear state estimation system of claim 15, wherein the frictional energy based wear state estimator includes a frictional energy calculator, and the frictional energy calculator receives the selected tire parameters and the selected vehicle parameters to calculate a frictional energy of the at least one tire.

17. The tire wear state estimation system of claim 15, wherein the model reliability for the frictional energy based wear state estimator includes a frictional energy based reliability score function that scores frictional energy based sensitivity parameters to generate the model reliability score for the frictional energy based wear state estimator.

18. The tire wear state estimation system of claim 17, wherein the frictional energy based sensitivity parameters include at least one of an ambient temperature of the at least one tire, a road surface condition, and a road roughness condition.

19. The tire wear state estimation system of claim 1, wherein plurality of sub-models includes at least one of a vibration based wear state estimator, a cornering stiffness based wear state estimator, a braking stiffness based wear state estimator, a footprint length based wear state estimator, and a tire wear state estimator based on analysis of parameter combinations including at least one of tire mileage, weather, and tire construction.

20. The tire wear state estimation system of claim 1, further comprising an estimate of a wear state of the at least one tire at a previous time step being received as an input into the supervisory model.
